(19) United States
(12) Patent Application Publication
(10) Pub. No.: US 2023/0267828 A1
(43) Pub. Date: Aug. 24, 2023

(54) DEVICE FOR AND METHOD OF PREDICTING A TRAJECTORY FOR A VEHICLE

(71) Applicant: Dr. Ing. h.c. F. Porsche Aktiengesellschaft, Stuttgart (DE)

(72) Inventor: Gabriel Berecz, Cluj Napoca (RO)

(21) Appl. No.: 18/020,522

(22) PCT Filed: Aug. 10, 2020
(86) PCT No.: PCT/EP2020/025368

§ 371 Date: Feb. 9, 2023

(51) Int. Cl. G08G 1/01; B60W 50/00; G08G 1/04

(52) U.S. Cl. CPC G08G 1/0112; B60W 50/0097; G08G 1/04; B60W 2554/4046; B60W 2554/408; B60W 2420/42; B60W 2420/52

(57) ABSTRACT

A method for predicting a trajectory (108) of a vehicle (102) uses first data captured by a first sensor of a first vehicle (101) to determine a first position, a first acceleration, a first velocity and a first yaw rate of a second vehicle (102) and uses second data captured by a second sensor of the first vehicle (101) to determine a second position, a second acceleration, a second velocity and a second yaw rate of the second vehicle (102). The method uses these first and second sets of information with a vehicle model to determine first and second lists of points for predicting the trajectory. One or more parameters of a model for the prediction of the trajectory (108) are determined depending on the first and second lists of points, and the prediction of the trajectory (108) is determined depending on the model defined by these parameters.

### CROSS REFERENCE TO RELATED APPLICATION

This application is filed as the national phase of PCT/EP2020/025368 filed Aug. 10, 2020.

### BACKGROUND

Field of the Invention. The invention concerns a device for and method of predicting a trajectory for a vehicle.

Related Art. CN 108803617 discloses aspects of a related device using an artificial neural network.

### SUMMARY OF THE INVENTION

A method is provided for predicting a trajectory for a vehicle. The method comprises using a first sensor of a first vehicle for capturing first data, and, depending on the first data that is captured by the first sensor of the first vehicle, the method proceeds by determining a first position, a first acceleration, a first velocity and a first yaw rate of a second vehicle. Depending on the first position, the first acceleration, the first velocity and the first yaw rate, the method proceeds by using a vehicle model for determining a first list of points for a prediction of the trajectory. The method continues by using second data, that is captured by a second sensor of the first vehicle for determining a second position, a second acceleration, a second velocity and a second yaw rate of the second vehicle. The method the uses the second position, the second acceleration, the second velocity and the second yaw rate of the second vehicle in conjunction with the vehicle model for determining a second list of points for the prediction of the trajectory. One or more parameters of the vehicle model for the prediction of the trajectory are determined depending on the first list of points and the second list of points, and the prediction of the trajectory is determined depending on the model defined by these parameters. Unless a history for the second vehicle is available, the data of each of the sensors is used independently to determine the position, acceleration, velocity and yaw rate. The vehicle model for this may be a CYRA model. By this method, the list of points for each sensor is determined independently from the other sensor data. The prediction is determined by fitting a curve to these points. The resulting prediction for the trajectory fits very well to the actual trajectory of the second vehicle.

In some embodiments, the first data is captured by the first sensor in a predetermined first period of time, and, depending on the first data, a first list of positions of the second vehicle in the first period of time is determined. Additionally, the second data is captured by the second sensor in the predetermined first period of time, and, depending on the second data, a second list of positions of the second vehicles in the first period of time is determined. In accordance with these aspects of the invention, parameters of the model are determined depending on the first list of positions and the second list of positions. If a history is available for the second vehicle, one or more positions from a previous trajectory of the second vehicle are used to improve the curve fitting further.

In some embodiments, a length of the first period of time is between 0.1 to 5 seconds, and preferably 1 second in some embodiments.

Some embodiments include using the first sensor of the first vehicle for capturing third data and depending on third data, that is captured by the first sensor of the first vehicle, a third position, a third acceleration, a third velocity and a third yaw rate of a third vehicle is determined. Depending on the third position, the third acceleration, the third velocity and the third yaw rate a third list of points for a prediction of the trajectory is determined with the vehicle model. Additionally, this aspect of the invention may use the second sensor of the first vehicle for capturing fourth data. The method then uses the captured fourth data for determining a fourth position, a fourth acceleration, a fourth velocity and a fourth yaw rate of a fourth vehicle. The method then uses the fourth position, the fourth acceleration, the fourth velocity and the fourth yaw rate with the vehicle model for predicting a fourth list of points of the trajectory. The one or more parameters for the prediction of the trajectory of the second vehicle are determined depending on the first list of points, the second list of points, the third list of points and the fourth list of points, and/or the one or more parameters for the prediction the trajectory of the third vehicles are determined depending on the first list of points, the second list of points, the third list of points and the fourth list of points with a model for the prediction of the trajectory of the third vehicle. This improves the prediction because the trajectory is predicted based on the third vehicle as well. Data of a plurality of vehicles surrounding the first vehicle may be captured and used alike.

In some embodiments, third data, captured by the first sensor in the predetermined first period of time is used for determining a third list of positions of the third vehicle in the first period of time. Additionally, fourth data, captured by the second sensor in the predetermined first period of time is used for determining a fourth list of positions of the third vehicle in the first period of time. The one or more parameters of the models for the second vehicle and/or the one or more parameters for the model for the third vehicle are determined depending on the first list of positions, the second list of positions, the third list of positions and the fourth list of positions. This improves the curve fitting further.

The first sensor and the second sensor may be one or more different sensors selected from the group consisting of radar sensor, camera and LiDAR-sensor.

The one or more parameters of some embodiments are determined by a least squares method.

The prediction of the trajectory in some embodiments is determined by quadratic programming.

In some embodiments, the prediction of the trajectory is determined depending on the vehicle model for a second period of time of up to 0.4 seconds in advance and/or depending on the vehicle model and depending on data captured in the first period of time for a third period of time between 0.4 and 5 seconds in advance.

The device for predicting a trajectory of a vehicle comprises a processor adapted to process input data from at least one of two different sensors of the group of radar sensor, camera and LiDAR-sensor and to execute the method.

### BRIEF DESCRIPTION OF THE DRAWINGS

FIG. 1 schematically depicts a road.

FIG. 2 depicts steps in a method for predicting a trajectory.

### DETAILED DESCRIPTION

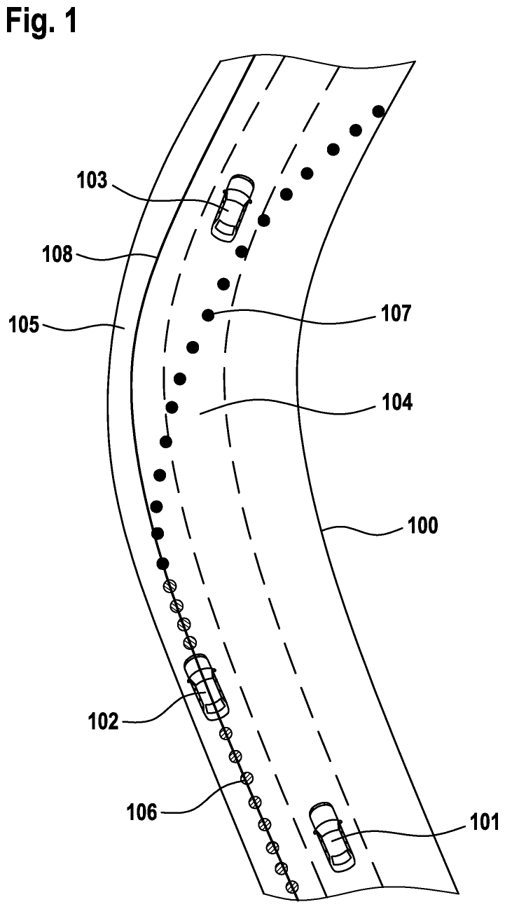

FIG. 1 depicts a road 100, a first vehicle 101, a second vehicle 102 and a third vehicle 103.

The first vehicle 101 comprises a device for predicting a trajectory of the second vehicle 102 and/or the third vehicles 103.

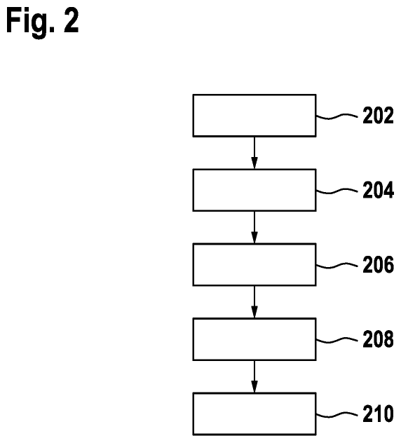

The device comprises a processor adapted to process input data of at least two different sensors selected from the group consisting of radar sensor, camera and LiDAR-sensor and to perform the steps of the method described below. The elements shown schematically in the FIGS. 1 and 2 may be implemented in various forms of hardware, software or combinations thereof. It will be appreciated by those skilled in the art that the block diagram presented in FIG. 2 represents conceptual views of illustrative components embodying the principles of the disclosure. Preferably, these elements are implemented in a combination of hardware and software on one or more appropriately programmed general-purpose devices that may include a processor, memory and input/output interfaces.

The first vehicle 101 comprises in the example a first sensor and a second sensor.

The first sensor and the second sensor are in the example different sensors of the group radar sensor, camera and LiDAR-sensor.

The first sensor in the example is a camera. The second sensor in the example is a radar sensor. A third sensor, e.g. the LiDAR-sensor may be provided as well.

The first vehicle 101 moves in the example on a middle lane 104 of three lanes of the road 100. The second vehicle moves in the example on a lane 105 left of the middle lane 104 in direction of travel of the first vehicle 101 and of the second vehicle 102. The third Vehicle 103 moves in the example on the middle lane 104.

FIG. 1 depicts a historic trajectory 106 for the second vehicle 102. FIG. 1 also depicts a trajectory 107 predicted by the vehicle model for the second vehicle 102 and a prediction for the trajectory 108 for the second vehicle 102 that has been determined by the method described below for the second vehicle.

The method for predicting the trajectory 108 for the second vehicle 102 comprises, a step 202 of:

a) capturing first data with the first sensor of the first vehicles 101, where the first data comprises at least one data type selected from a first position, a first acceleration, a first velocity and a first yaw rate of the second vehicle 102; and

b) capturing second data with the second sensor of the first vehicles 101, where the second data comprises at least one data type selected from a second position, a second acceleration, a second velocity and a second yaw rate of the second vehicle 102.

The method may further comprise capturing third data with the first sensor third data. The third data may comprise at least one data type selected from a third position, a third acceleration, a third velocity and a third yaw rate of the third vehicle 103.

The method may comprise capturing fourth data with the second sensor. The fourth data may comprise at least one data type selected from a fourth position, a fourth acceleration, a fourth velocity and a fourth yaw rate of the third vehicle 103.

The method may comprise using the first sensor and the second sensor for capturing data in a predetermined first period of time.

A length of the first period of time may be between 0.1 and 5 seconds and is preferably 1 second. A first list of positions, a second list of positions, a third list of positions and/or a fourth list of positions may be determined in the first period of time.

The method comprises a step 204 of using the data of the first sensor for determining the first position, the first acceleration, the first velocity and the first yaw rate of the second vehicle 102 and using the data of the second sensor for determining the second position, the second acceleration, the second velocity and the second yaw rate of the second vehicle 102.

The method may comprise using the data of the first sensor for determining the third position, the third acceleration, the third velocity and the third yaw rate of the third vehicles 103.

The method may comprise using the data of the second sensor for determining the fourth position, the fourth acceleration, the fourth velocity and the fourth yaw rate of the third vehicles 103.

The method comprises a step 206 of: a) using the first position, the first acceleration, the first velocity and the first yaw rate as input with the vehicle model for determining a first list of points for the prediction of the trajectory 108, and b) using the second position, the second acceleration, the second velocity and the second yaw rate as input with the vehicle model for determining a second list of points for the prediction of the trajectory 108.

The method may comprise using the third position, the third acceleration, the third velocity and the third yaw rate as input with the vehicle model for determining a third list of points for the prediction of a trajectory for the third vehicle 103.

The method may comprise using the fourth position, the fourth acceleration, the fourth velocity and the fourth yaw rate as input with the vehicle model for determining a fourth list of points for the prediction of the trajectory for the third vehicle 103.

The vehicle model in the example is a CYRA model.

The method comprises a step 208 of determining, depending on the first list of points and the second list of points, one or more parameters of a model for the prediction the trajectory 108 for the second vehicle 102.

The one or more parameters for the prediction of the trajectory 108 of the second vehicle 102 may be determined depending on the first list of points, the second list of points, the third list of points and the fourth list of points by using the model for the prediction of the trajectory 108 of the second vehicle 102.

The method may comprise, determining the one or more parameters for the prediction of the trajectory of the third vehicle 103 depending on the first list of points, the second list of points, the third list of points and the fourth list of points by using a model for the prediction the trajectory of the third vehicle 103.

The one or more parameters of the model for the second vehicle 102 and/or the one or more parameters for the model for the third vehicle 103 may be determined depending on the first list of positions, the second list of positions, the third list of positions and the fourth list of positions.

The parameters may be estimated by the least squares method or by quadratic programming. The parameter define in the example a curve having a curvature K.

The method comprises a step 210 of determining the prediction of the trajectory 108 depending on the model that is defined by these parameters.

For each sensor a list of points for the prediction is determined independently of the other sensors. The prediction is based on a curve fitting to these points. If the history is available, the curve fitting considers the previous positions from available lists of positions as well.

The prediction for the trajectory 108 that is based on the vehicle model may be for a second period of time of up to 0.4 seconds in advance.

The prediction for the trajectory 108 that is based on the vehicle model and the data from the first period of time may be for a third period of time between 0.4 seconds and 5 seconds in advance.

In an example, for the prediction the trajectory 108 the yaw angle of the second vehicle 102 is estimated with quadratic programming, i.e. solving a quadratic optimization problem. The quadratic optimization problem in the example is defined assuming a constant acceleration:

$$K = \frac{\vert {y}^{″} \vert}{{[ 1 + {( {y}^{′} )}^{2} ]}^{\frac{3}{2}}} , R = \frac{1}{K} , R = \frac{v}{ω} ,$$

wherein y is the solution to the quadratic optimization problem, R is a curve radius of the curve having the curvature K, v is the velocity and w the yaw rate of the second vehicle 102.

The quadratic optimization problem may be solved to estimate the yaw angle for the prediction the trajectory for the third vehicle 103. The prediction of the trajectory 108 for the second vehicle 102 may be determined depending on the data and depending on the parameter for the model for the second vehicle 102 and the model for the third vehicle 103. The quadratic optimization problem may be used for estimating yaw angles for the prediction of the trajectory for a plurality of vehicles. Assumptions about predicted paths of different vehicles captured by the sensors of the first vehicle 101 may be determined from the predictions of the trajectory of these vehicles and to improve the prediction of the trajectories for the vehicles.

1. A method of predicting a trajectory (108) for a vehicle (102), comprising:
using a first sensor of a first vehicle (101) for capturing first data of a second vehicle (102);
using the first data of the second vehicle (102) for determining (204) a first position, a first acceleration, a first velocity and a first yaw rate of the second vehicle (102);
using the first position, the first acceleration, the first velocity and the first yaw rate with a vehicle model for determining (206) a first list of points for a prediction of the trajectory (108);
using a second sensor of the first vehicle (101) for capturing second data of the second vehicle (102);
using the second data of the second vehicle (102) for determining (204) a second position, a second acceleration, a second velocity and a second yaw rate of the second vehicle (102);
using the second position, the second acceleration, the second velocity and the second yaw rate with the vehicle model for determining a second list of points for the prediction of the trajectory (108);
using the first list of points and the second list of points for determining (208) parameters of a model for the prediction of the trajectory (108); and
using the model defined by these parameters (210) for predicting the trajectory (108).

2. The method of claim 1, further comprising:
using the first data captured (202) by the first sensor in a predetermined first period of time for determining a first list of positions of the second vehicle (102) in the first period of time;
using the second data captured (202) by the second sensor in the predetermined first period of time for determining a second list of positions of the second vehicles (102) in the first period of time; and
determining (208) the parameters of the model depending on the first list of positions and the second list of positions.

3. The method of claim 2, wherein a length of the first period of time is between 0.1 to 5 seconds.

4. The method of claim 1, further comprising:
using the first sensor of the first vehicle (101) for capturing third data of a third vehicle (103);
using the third data for determining (204) a third position, a third acceleration, a third velocity and a third yaw rate of the third vehicle (103);
using the third position, the third acceleration, the third velocity and the third yaw rate with the vehicle model for determining a third list of points for a prediction of the trajectory (108);
using the second sensor of the first vehicle (101) for capturing fourth data of a fourth vehicle (104);
using the fourth data for determining a fourth position, a fourth acceleration, a fourth velocity and a fourth yaw rate of the fourth vehicle (102);
using the fourth position, the fourth acceleration, the fourth velocity and the fourth yaw rate with the vehicle model for determining a fourth list of points for the prediction of the trajectory (108) of the second vehicle (102);
using the first list of points, the second list of points, the third list of points and the fourth list of points for determining the one or more parameters for predicting the trajectory (108) of the second vehicle (102); and
determining the one or more parameters for predicting the trajectory of the third vehicles (103) depending on the first list of points, the second list of points, the third list of points and the fourth list of points with a model for the prediction of the trajectory of the third vehicle (103).

5. The method of claim 4, further comprising:
using third data captured (202) by the first sensor in the predetermined first period of time for determining a third list of positions of the third vehicle (103) in the first period of time;
using fourth data captured (202) by the second sensor in the predetermined first period of time for determining a fourth list of positions of the third vehicle (103) in the first period of time;
determining the one or more parameters of the model for the second vehicle (102) and/or the one or more parameters for the model for the third vehicle (103) depending on the first list of positions, the second list of positions, the third list of positions and the fourth list of positions.

6. The method of claim 1, wherein the first sensor and the second sensor are different sensors selected from the group consisting of radar sensor, camera and LiDAR-sensor.

7. The method of claim 1, wherein the one or more parameters are determined (206) by a least squares method.

8. The method of claim 1, wherein the prediction of the trajectory (108) is determined (208) by quadratic programming.

9. The method of claim, wherein the prediction of the trajectory (108) is determined depending on the vehicle model for a second period of time of up to 0.4 seconds in advance and/or depending on the vehicle model and depending on data captured in the first period of time for a third period of time between 0.4 and 5 seconds in advance (210).

10. A device for predicting a trajectory of a vehicle (102), comprising a processor adapted to process input data from at least one of two different sensors of the group consisting of radar sensor, camera and LiDAR-sensor and to execute the method of claim 1.
